(19) United States
(12) Patent Application Publication
(10) Pub. No.: US 2012/0039552 A1
(43) Pub. Date: Feb. 16, 2012

(54) SINTERED METAL BEARING, SHAFT MEMBER FOR A PLAIN BEARING UNIT, AND PLAIN BEARING UNIT PROVIDED WITH SAID SHAFT MEMBER

(75) Inventors: Tomoya Sakaguchi, Kuwana-shi (JP); Norihide Sato, Kuwana-shi (JP)

(73) Assignee: NTN CORPORATION, Osaka-shi, Osaka (JP)

(21) Appl. No.: 13/265,986

(22) PCT Filed: May 13, 2010
(86) PCT No.: PCT/JP2010/058077

§ 371 Date: Oct. 24, 2011

(30) Foreign Application Priority Data
May 19, 2009 (JP) 2009-121035
Jun. 23, 2009 (JP) 2009-148700

(51) Int. Cl. F16C 17/02; F16C 33/24

(52) U.S. Cl. 384/397

(57) ABSTRACT

A sintered metal bearing includes: a sintered-metal bearing body formed of a metal different from a metal of a shaft and including a large number of inner pores; and a resin film formed on predetermined parts of a surface of the sintered-metal bearing body and forming a sliding surface. The resin film is formed so that surface openings communicating to the inner pores are kept opened, and resin-film parts adhere to a surface of the shaft. Further, a shaft member used for a sliding bearing unit is incorporated in a sintered-metal sliding bearing including copper mainly or copper and iron, the shaft member including a sliding surface. The shaft member includes: a metal shaft body; and a resin film formed on predetermined parts of a surface of the metal shaft body and forming the sliding surface. The resin film is made of a resin excellent in adhering properties.

### TECHNICAL FIELD

The invention of the present application relates to a sintered metal bearing, a shaft member for sliding bearing unit, and a sliding bearing unit provided with the shaft member, and more particularly, to a sintered metal bearing and a shaft member for sliding bearing unit which are excellent in quietness at low temperature, and a sliding bearing unit provided with the shaft member.

### BACKGROUND ART

As one example of a bearing suitably used as a sliding bearing, there is a sintered oil-retaining bearing. In the sintered oil-retaining bearing, a lubricating oil is impregnated in inner pores of a bearing made of a sintered metal (sintered metal bearing). The bearings of this type are excellent in quietness during use in comparison with that of a ball bearing and the like, and can be produced at markedly low cost. Thus, the bearings of this type are suitably used not only for industrial machines, but also for drive systems of appliances having an influence on comfort in manual operation, such as small electric motors of automobiles, office appliances, domestic appliances, and the like.

By the way, in a case where the above-mentioned sintered metal bearing is used for, for example, the small electric motors, when the motor is stopped and activated after being put for a long period of time in a low temperature environment, abnormal noise called squealing noise is generated in some cases. It is considered that the squealing noise is generated by depletion of a lubricating oil on a sliding surface, the lubricating oil being depleted by being drawn into the bearing at low temperature owing to a higher linear expansion coefficient of the lubricating oil than that of a bearing body made of a sintered metal.

Up to now, there have been proposed a large number of countermeasures against problems of this type. For example, Patent Literature 1 below discloses an attempt to reduce a generation frequency of the squealing noise by adjusting a constitution of a sintered metal composition, air permeability, and viscosity of the lubricating oil in the sintered oil-retaining bearing.

Further, Patent Literature 2 below describes that an attempt is made to reduce depletion of the lubricating oil at low temperature by adjusting a percentage of surface openings each having a predetermined area on a bearing surface based on a size of a clearance between the sintered oil-retaining bearing and a shaft (bearing gap).

However, the method disclosed in Patent Literature 1 below is devised only on the premise of leaving an appropriate amount of a lubricating oil on the sliding surface. Thus, it is difficult to obtain a sufficient effect when viscosity of the lubricating oil is high. Further, by the method disclosed in Patent Literature 2 below, it is difficult to prevent generation of the squealing noise to an originally expected extent. This is because forms of the surface openings in the bearing surface vary in accordance with rotary sliding of the shaft, and when the bearing gap varies owing to development of bearing abrasion, the forms of the surface openings are different from those in an initial state.

For example, as in Patent Literature 3 below, in order to prevent rotation-efficiency reduction caused by deficiency of a lubricating oil and to prolong a life, in some cases, a non-porous resin layer is formed in a part of the sliding surface of the sintered oil-retaining bearing. In this sintered oil-retaining bearing, by replacing a part of the sintered-metal sliding surface with a resin sliding surface free from opening portions, metal contact with respect to the shaft is reduced, and an oil is prevented from relieving into the bearing. However, this structure is inferior to those of the sintered oil-retaining bearings in life in a high temperature environment. Further, above all, the openings in the bearing surface are closed by the resin layer, and hence the lubricating oil is not sufficiently supplied, which may lead to a risk of deterioration of slidability.

For example, Patent Literature 4 below discloses a sintered friction member (clutch) in which a resin layer containing a solid lubricant is formed in a superficial portion of a porous sintered body while preventing holes of the sintered body from being closed, and the resin layer and a mating member slide relative to each other in a lubricating oil. Thus, when this structure is applicable to the sintered oil-retaining bearing, it seems that the lubricating oil can be supplied to a surface of the resin layer to serve as the sliding surface while avoiding contact of the sintered metal and the mating member. However, actually, even with such a structure, the oil is still drawn into the bearing at low temperature. In this case, it is necessary to support the mating member only with the resin layer. Further, in Patent Literature 4 below, the resin layer is introduced to the friction member for the purpose of preventing the solid lubricant from dropping. Thus, the resin layer containing the solid lubricant is required to have a rather large thickness, which leads to difficulty in coping with small holes (holes are closed by the resin). In addition, elasticity is lower than that of the metal sliding surface, and microscopic contact area increases. Thus, adversely, there is a risk that a frictional coefficient becomes higher.

Further, the above-mentioned problems with squealing noise can occur not only at the time of activation at low temperature but also in other various situations. For example, copiers in offices, which are used over a long time period, constantly generate squealing noise in some cases. In particular, in many cases, quietness is required depending on work environments in the offices and the like. Thus, measures for preventing squealing noise have been strongly demanded.

### CITATION LIST

Patent Literature 1: JP 2003-120674 A
Patent Literature 2: JP 2004-138215 A
Patent Literature 3: JP 2002-39183 A
Patent Literature 4: JP 2000-130484 A

### SUMMARY OF INVENTION

### Technical Problems

In view of the above-mentioned circumstances, a first technical object disclosed in this specification is to provide a sintered metal bearing capable of suppressing generation of abnormal noise such as squealing noise while exerting high sliding properties.

Further, in view of the above-mentioned circumstances, a second technical object disclosed in this specification is to suppress generation of abnormal noise such as squealing noise while exerting high sliding properties in the sliding bearings of this type.

### Solution to Problems

The above-mentioned first technical object is achieved by a sintered metal bearing according to a first invention of the present application. That is, the sintered metal bearing includes: a sliding surface relative to a shaft; a sintered-metal bearing body formed of a metal composition different from a metal composition of the shaft and including a large number of inner pores; and a resin film formed on predetermined parts of a surface of the sintered-metal bearing body and forming the sliding surface, in which the resin film is formed so that surface openings communicating to the large number of inner pores are kept opened, and the resin film partially peels from the sintered-metal bearing body in accordance with relative sliding relative to the shaft to adhere to a surface of the shaft.

As a result of a survey of causes of generation of squealing noise during bearing use, the inventors of the present application have found that, when marked squealing noise is generated, a metal forming the sliding surface of the sintered metal bearing adheres to a surface of the shaft. When the metal forming the sliding surface of the bearing partially peels in accordance with sliding relative to the shaft and adheres to the shaft, the metal having adhered to the shaft and the metal forming the sliding surface of the bearing come into sliding contact with each other, and aggregation occurs owing to the metal of the same type. In this case, a frictional coefficient is high. Meanwhile, the frictional coefficient is relatively low when parts of the surface of the shaft, to which the peeled metal pieces have not adhered, and the bearing slide relative to each other. In summary, it is probable that, when the metal forming the sliding surface of the bearing starts to peel and adhere to the surface of the shaft, a variation range of the frictional coefficient between the sliding surfaces increases, with the result that a contact of the sliding surfaces constitutes a vibration source to cause vibration. Therefore, the vibration is assumed to generate the abnormal noise.

The first invention of the present application has been made based on the above-mentioned new findings. Specifically, according to the sintered metal bearing of the first invention of the present application, the resin film formed on a surface to serve as the sliding surface of the sintered-metal bearing body partially peels from the bearing body at the time of coming into sliding contact with the shaft, and the peeled parts adhere to the surface of the shaft. In this way, also when the metal composition forming the sintered metal is exposed on the sliding surface in accordance with peeling of the resin film, the exposed parts of the metal come into sliding contact with parts of the resin film adhering to the surface of the shaft. Thus, the exposed parts of the metal are prevented from aggregating between the shaft and the bearing, and vibration derived from the aggregation or generation of abnormal noise (squealing noise) caused by the vibration can be suppressed. Further, when the resin film partially peels and adheres to the shaft, the sliding surface is re-constituted by residual unpeeled parts of the resin film and parts of the metal composition forming the sintered-metal bearing body exposed by the peeling of the resin film. In this case, for example, when the sintered-metal bearing body is made of a metal excellent in conformability (initial sliding properties) with respect to the shaft so that sliding properties (mechanical properties) different depending on the metal composition of the resin film and the metal composition of the sintered-metal bearing body are imparted to the sliding surface, the bearing performance can be comprehensively enhanced. As a matter of course, in a phase prior to occurrence of peeling, the sliding surface is formed of the resin film, and hence there is no risk of occurrence of aggregation. Therefore, abnormal noise is not generated irrespective of low temperature and high temperature.

Here, the metal composition of the sintered-metal bearing body may include at least two types of metals each having different adhering properties with respect to the resin film, and the resin film may peel from one of the at least two types of the metals forming the metal composition (including not only a single metal composition but also an alloy composition. “Another of the at least two types of the metals” has a similar meaning.) at the time of the relative sliding relative to the shaft and may maintain a adhering state with respect to another of the at least two types of the metals.

With this structure, of the predetermined parts of the surface of the sintered-metal bearing body, on which the resin film is formed, the resin film peels from parts formed of the one of the at least two types of the metals and the one of the at least two types of the metals is exposed, and the resin film is maintained at parts formed of the another of the at least two types of the metals. Thus, when metals forming the sintered metal are adjusted (normally, formulation percentages and grain sizes of metal powders) in advance in a phase of preparing the sintered-metal bearing body, percentages of the metal exposed surface and the surface covered with the resin film with respect to the sliding surface can be adjusted. As a matter of course, when the sintered-metal bearing body and the resin film are formed as described above, the resin film peels and adheres to the shaft surface uniformly over the entire of the sliding surface. Thus, the above-mentioned aggregation is prevented over the entire of the sliding surface.

Further, the resin film may be made of a resin excellent in adhering properties with respect to the shaft than with respect to the sintered-metal bearing body

Normally, easiness of peeling the resin film formed over the bearing body varies in accordance with a rotational speed of and load from the shaft which relatively slides. Further, materials for the shaft and the bearing need to be selected in consideration not only of adhering properties with respect to the resin film but also of other factors (strength, rigidity, abrasion resistance, conductivity, processability, and the like). Thus, judgment cannot be easily made as to which types of resin (film) should be selected. In this context, for example, when the film is made of a resin satisfying the above-mentioned conditions, the parts peeled from the bearing body can be reliably stuck to the surface of the shaft without an influence on selection of the materials for the shaft and the bearing. Further, when the parts peeled by the sliding contact from the bearing body adhere as they are to the surface of the shaft, peeling positions and adhering positions face each other. Thus, the parts of the metal, which are exposed owing to peeling, can be reliably brought into sliding contact with the parts of the resin film having stuck to the surface of the shaft. With this, aggregation of the parts of the exposed metal is prevented at higher probability.

Further, the resin film can be made of any type of resin as long as the resin can partially peel from the bearing body and adhere to the surface of the shaft. However, as described above, in terms of excellence in adhering properties with respect to the surface of the shaft (easiness of peeling from the bearing body), thermosetting resins may be used. Further, the resin film may be made of one type of resin selected from a group consisting of an acrylic resin, an epoxy resin, a phenolic resin, and an unsaturated polyester resin of the thermosetting resins. The selection from the group is effective normally in selecting materials satisfying characteristics required respectively for the shaft and the bearing body (iron-based material for the shaft, and copper-based or copper-iron based material for the bearing body).

Further, in the sintered metal bearing according to the first invention of the present application, the sliding surface is formed of the resin film. Meanwhile, the surface openings communicating to the large number of inner pores of the sintered-metal bearing body are kept opened in the sliding surface without being closed. Thus, the lubricating oil may be impregnated in the large number of inner pores.

The sintered metal bearing structured as described above includes the sliding surface formed of the resin film. Thus, when being used, for example, during rotation at relatively low speed, under low load, or under high friction, the sintered metal bearing can be used without particular problems even without lubricant. Further, as described above, the sliding surface is formed of the resin film, and the surface openings communicating to the large number of inner pores of the sintered-metal bearing body are kept opened in the sliding surface without being closed. Thus, the lubricating oil can be impregnated in the large number of inner pores of the sintered-metal bearing body, and the impregnated lubricating oil can be supplied onto the sliding surface at the time of relative sliding of the shaft. With this, a satisfactory sliding state equivalent to or more satisfactory than those of conventional sintered metal bearings can be achieved even under high-speed rotation or under high load. As a matter of course, even when the present invention is used as a sintered oil-retaining bearing, generation of abnormal noise can be suppressed by the resin films respectively stuck to the shaft and the bearing even at the time of lubrication deficiency at low temperature. Further, the peeled parts of the resin film are not contained as impurities in the lubricating oil, and hence performance of the lubricating oil is not deteriorated.

Further, the sintered metal bearing structured as described above may be provided as a component of a bearing device including the sintered oil-retaining bearing, and the shaft arranged along an inner periphery of the sintered metal bearing.

The sintered metal bearing described hereinabove is capable of suppressing generation of abnormal noise not only at low temperature but also at high temperature, excellent in slidability, and can be manufactured at low cost. Thus, the sintered metal bearing can be suitably used as sliding bearings for electric motors of automobiles used in cold regions and for motors of electronic devices built in the automobiles. As a matter of course, the sintered metal bearing can be suitably used as sliding bearings for devices operated at high temperature and used for a relatively long time period, such as fan motors built in printers, copiers, and various electronic devices, specifically, appliances used in offices and houses in which squealing noise and the like can discomfort users.

Further, the above-mentioned second technical object is achieved by a shaft member for sliding bearing unit according to a second invention of the present application. That is, the shaft member for sliding bearing unit, which is to be used for a sintered-metal sliding bearing including one type of a metal composition or two or more types of metal compositions, includes: a sliding surface relative to the sintered-metal sliding bearing; a metal shaft body; and a resin film formed on predetermined parts of a surface of the metal shaft body and forming the sliding surface, in which the resin film is made of a resin excellent in adhering properties with respect to the metal shaft body than with respect to predetermined one of the one type of the metal composition or the two or more types of the metal compositions forming the sintered-metal sliding bearing, and the resin film only partially peels from the metal shaft body in accordance with relative sliding relative to the sintered-metal sliding bearing.

As a result of a survey of causes of generation of squealing noise during use of the sintered-metal sliding bearing, the inventors of the present application have found that, when marked squealing noise is generated, a metal forming the sliding surface of the sintered metal bearing adheres to a surface of the shaft member. When the metal forming the sliding surface of the bearing partially peels in accordance with sliding relative to the shaft member and adheres to the shaft member, the metal having adhered to the shaft member and the metal forming the sliding surface of the bearing come into sliding contact with each other, and aggregation occurs owing to the metal of the same type. In this case, a frictional coefficient is high. Meanwhile, the frictional coefficient is relatively low when parts of the surface of the shaft member, to which the peeled metal pieces have not adhered, and the bearing slide relative to each other. In summary, it is probable that, when the metal forming the sliding surface of the bearing starts to peel and adhere to the surface of the shaft member, a variation range of the frictional coefficient between the sliding surfaces increases, with the result that a contact of the sliding surfaces constitutes a vibration source to cause vibration. Therefore, the vibration is assumed to generate the abnormal noise.

Similarly to the first invention, the second invention of the present application has been made by the inventors of the present application based on the above-mentioned new findings as a result of the survey of the causes of generation of squealing noise. In the second invention of the present application, measures for preventing aggregation are taken not on the sintered-metal sliding bearing side but on the shaft member for sliding bearing unit side. Specifically, in the shaft member for sliding bearing unit according to the second invention of the present application, the sliding surface relative to the sintered-metal sliding bearing is formed of the resin film, and the resin film is made of the resin excellent in adhering properties with respect to the metal shaft body than with respect to the predetermined one of the metal compositions forming the sintered-metal sliding bearing. Thus, basically, peeling is less liable to occur at parts which come into sliding contact with the sliding surface of the sintered-metal sliding bearing. Even when peeling occurs, the peeling is only partially performed (because the adhering properties between the resin film and the metal shaft body are higher than the adhering properties between the resin film and the sliding surface of the sintered-metal sliding bearing). With this, it is possible to avoid a situation in which the one of the metal compositions forming the sliding surface of the sintered-metal sliding bearing and the metal shaft body come into direct contact with each other, and a situation in which aggregation occurs between the shaft member for sliding bearing unit and the bearing is prevented as much as possible. Accordingly, vibration caused by the aggregation, by extension, generation of abnormal noise (squealing noise) derived from the vibration can be suppressed.

Further, with use of the metal shaft (shaft body), dimensional accuracy and surface accuracy can be easily enhanced in comparison with the sintered-metal sliding bearing. Therefore, the dimensional accuracy and the like of the shaft member obtained by forming the resin film on the shaft body are higher than those in the case where the resin film is formed on the sintered metal bearing. As a result, for example, when the resin film is formed to only partially peel owing to the relative sliding relative to the sliding bearing through adjustment of a film thickness, it is possible to maintain the dimensional accuracy and the like of the shaft member after formation of the resin film to be high, and manage a bearing gap formed therebetween with high accuracy.

Further, as described above, in the second invention of the present application, the resin film is formed on the outer peripheral surface of the shaft member for sliding bearing unit. Thus, as a matter of course, it is unnecessary to form the resin film and the like with respect to the sliding bearing. In this way, conventional sintered metal bearings and sintered oil-retaining bearings can be used as the sliding bearing, and a satisfactory sliding lubricating state can be obtained through intermediation of the lubricating oil.

The resin film can be made of any type of resin as long as the resin is excellent in adhering properties with respect to the shaft body than with respect to predetermined one of the metal compositions forming the sliding bearing and only partially peels. For example, in terms of moldability, thermosetting resins can be used. Further, the resin film may be made of one type of resin selected from a group consisting of an acrylic resin, an epoxy resin, a phenolic resin, and an unsaturated polyester resin of the thermosetting resins. Those resins are effective normally when materials satisfying characteristics required respectively for the shaft member and the bearing body (iron-based material for the shaft member, and copper-based or copper-iron based material for the sliding bearing) are used.

The shaft member for sliding bearing unit structured as described above may be provided as a component of a sliding bearing unit including the shaft member and the sintered-metal sliding bearing having an inner periphery along which the shaft member is arranged.

Further, in this case, metal compositions weak in adhering force and excellent in slidability relative to the shaft body are suitable as the metal compositions forming the sliding bearing. For example, in consideration of compatibility with the above-mentioned thermosetting resins, a metal composition formed mainly of copper (including copper alone or compositions formed of copper alloys) can be exemplified. As a matter of course, the above-mentioned sliding bearing may be formed of two or more types of metal compositions. In this case, the plurality of metal compositions may be different from each other in adhering properties with respect to the resin film. As a specific example, a copper-iron based metal composition (metal composition formed mainly of copper and iron) can be exemplified.

In this context, when the former structure (metal composition formed mainly of copper) is employed, a material constitution of the sliding bearing may be set such that a proportion of copper is 50 wt % or more and 100 wt % or less. Specifically, formulation percentages of raw-material powders may be set such that a mixing proportion of a copper powder (not only a pure copper powder but also a copper-alloy powder) is 50 wt % or more and 100 wt % or less.

Further, when the shaft member for sliding bearing unit according to the second invention of the present application is combined with the sliding bearing having the latter structure (two or more types of metal compositions), the following advantages can be obtained. Specifically, of the sliding surface of the shaft member, in a region facing predetermined one of the metal compositions forming the sliding bearing, the resin film is less liable to peel for the above-mentioned reasons. Meanwhile, in a region facing another of the metal compositions forming the sliding bearing, peeling is liable to occur in comparison with the above-mentioned predetermined one of the metal compositions. Thus, in a phase of manufacturing the sliding bearing, by adjusting a constitution (for example, formulation percentages and grain sizes of metal powders as raw materials) in advance, percentages by which each of the predetermined one of the metal compositions and the another of the metal compositions faces the sliding surface, in other words, percentage of the parts to peel and the parts at which a adhering state is maintained can be adjusted. As a matter of course, when the sliding bearing and the resin film are formed as described above, peeling parts and adhering parts of the resin film are uniformly generated over the entire of the sliding surface. Thus, the above-mentioned aggregation is prevented over the entire of the sliding surface.

Further, in a sliding bearing unit according to the second invention of the present application, the resin film for preventing aggregation is formed on the shaft member side. Thus, any type of sintered-metal sliding bearing can be used. For example, a sintered metal bearing formed to be non-porous by closing the inner pores can be used. Alternatively, a sintered metal bearing in which a lubricating oil is impregnated in the inner pores can be used.

Still further, a shaft member of the sliding bearing unit according to the second invention of the present application has a sliding surface formed of the resin film. Thus, when being used, for example, during rotation at relatively low speed, under low load, or under high friction, the sliding bearing unit can be used without particular problems even without lubricant. In addition, as described above, the structure of the sliding bearing is arbitrarily selected in principle. Thus, in order to achieve a satisfactory sliding state under high-speed rotation or under high load, it suffices that the sliding bearing unit is used under the state in which the lubricating oil is impregnated in the inner pores.

The shaft member for sliding bearing unit and the sliding bearing unit provided with the shaft member for sliding bearing unit described hereinabove are capable of suppressing generation of abnormal noise not only at low temperature but also at high temperature, excellent in slidability, and can be manufactured at low cost. Thus, the shaft member for sliding bearing unit and the sliding bearing unit can be suitably used for bearings for electric motors of automobiles used in cold regions and for motors of electronic devices built in the automobiles. As a matter of course, the shaft member for sliding bearing unit and the sliding bearing unit can be suitably used for devices operated at high temperature and used for a relatively long time period, such as fan motors built in printers, copiers, and various electronic devices, specifically, appliances used in offices and houses in which squealing noise and the like can discomfort users.

### Advantageous Effects of Invention

With the sintered metal bearing according to the first invention of the present application, it is possible to provide a sintered metal bearing capable of suppressing generation of abnormal noise such as squealing noise while exerting high sliding properties.

Further, as described above, with the shaft member for sliding bearing unit according to the second invention of the present application, it is possible to suppress generation of abnormal noise such as squealing noise while exerting high sliding properties in the sliding bearings of this type.

### BRIEF DESCRIPTION OF DRAWINGS

FIG. 1 A vertical sectional view of a sintered metal bearing according to an embodiment of a first invention of the present application.

FIG. 2 An enlarged sectional view of a region A in FIG. 1, schematically illustrating a structure around a sliding surface of the sintered metal bearing prior to relative sliding of a shaft.

FIG. 3 An enlarged sectional view of the region A in FIG. 1, schematically illustrating the structure around the sliding surface of the sintered metal bearing after the relative sliding of the shaft.

FIG. 4 A vertical sectional view of a sliding bearing unit according to an embodiment of a second invention of the present application.

FIG. 5 An enlarged sectional view of a region B in FIG. 4, schematically illustrating a structure around a sliding surface of a shaft member for sliding bearing unit prior to relative sliding relative to a sliding bearing.

FIG. 6 An enlarged sectional view of the region B in FIG. 4, schematically illustrating the structure around the sliding surface of the shaft member for sliding bearing unit after the relative sliding relative to the sliding bearing.

### DESCRIPTION OF EMBODIMENTS

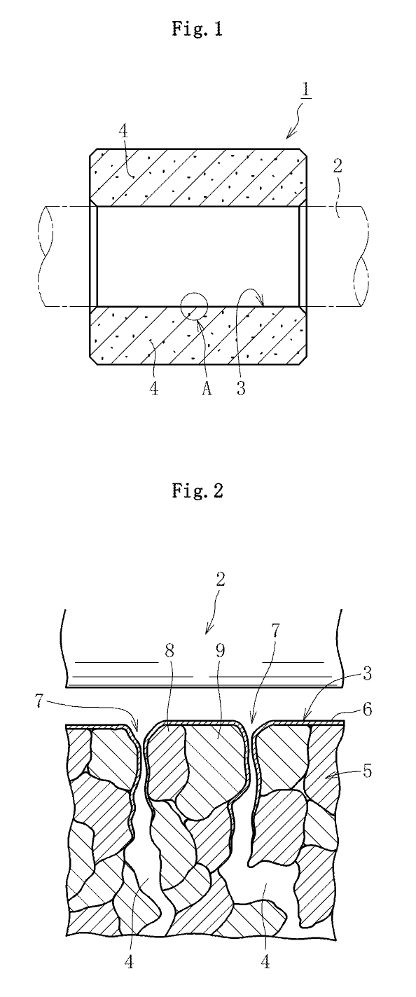

In the following, description is made of an embodiment of a sintered metal bearing according to a first invention of the present application with reference to FIGS. 1 to 3.

FIG. 1 is a vertical sectional view of a sintered metal bearing 1 according to the embodiment of the first invention of the present application. In this embodiment, the sintered metal bearing 1 has a cylindrical shape, and along an inner periphery thereof, a shaft 2 to be supported (refer to FIG. 1) is arranged. Further, a sliding surface 3 is provided in a region facing an outer peripheral surface of the shaft 2. Further, a large number of pores (inner pores 4) are provided in the sintered metal bearing 1, and a lubricating oil is impregnated in those inner pores 4. Those large number of inner pores 4 communicate to surface openings 7 (described below) opened in the sliding surface 3. In accordance with relative rotation of the shaft 2, the lubricating oil retained in the inner pores 4 seeps onto the sliding surface 3 through the surface openings 7.

FIG. 2 is an enlarged sectional view of the region A in FIG. 1, that is, around the sliding surface 3 of the sintered metal bearing 1. As illustrated in FIG. 2, the sintered metal bearing 1 includes a bearing body 5 formed of a porous sintered metal and a resin film 6 formed on predetermined parts of a surface of the bearing body 5, that is, at least in a region (inner peripheral surface) to serve as the sliding surface 3 relative to the shaft 2. In this case, the resin film 6 is formed without closing the surface openings 7 opened in the inner peripheral surface of the bearing body 5 and communicating to the inner pores 4. Thus, even under a state in which the resin film 6 is formed on the inner peripheral surface of the bearing body 5, the surface openings 7 remain on the sliding surface 3 without being closed.

The bearing body 5 is obtained by compression molding one type or two or more types of metal powders (including both single metals and alloys) as raw materials, and then sintering the same. In this embodiment, the bearing body 5 is formed of two types of metal powders, specifically, a copper powder and an iron powder as raw materials. Thus, as illustrated in FIG. 2, the bearing body 5 has a structure in which a composition 8 formed mainly of copper (hereinafter, simply referred to as copper composition) and another composition 9 formed mainly of iron (hereinafter, simply referred to as iron composition) are mixed with each other. In this case, the region to serve as the sliding surface 3 as a result of formation of the resin film 6 (inner peripheral surface of the bearing body 5) is formed of the copper composition 8 and the iron composition 9.

Further, in this case, the resin film 6 is formed in a state of adhering to both the copper composition 8 and the iron composition 9 forming the bearing body 5. As described below, a material, a film thickness, a film forming condition, and the like of the resin film 6 are set such that parts of the resin film 6 peel from the bearing body 5 in accordance with relative sliding relative to the shaft 2 and adhere to the outer peripheral surface of the shaft 2. As a matter of course, adhering properties of the resin film 6 with respect to the bearing body 5 and the shaft 2 may be set (resin as a material for the resin film 6 may be selected) in consideration of bearing use conditions such as a rotational speed of and load (surface pressure imparted to the sliding surface 3 during rotation) on the shaft 2.

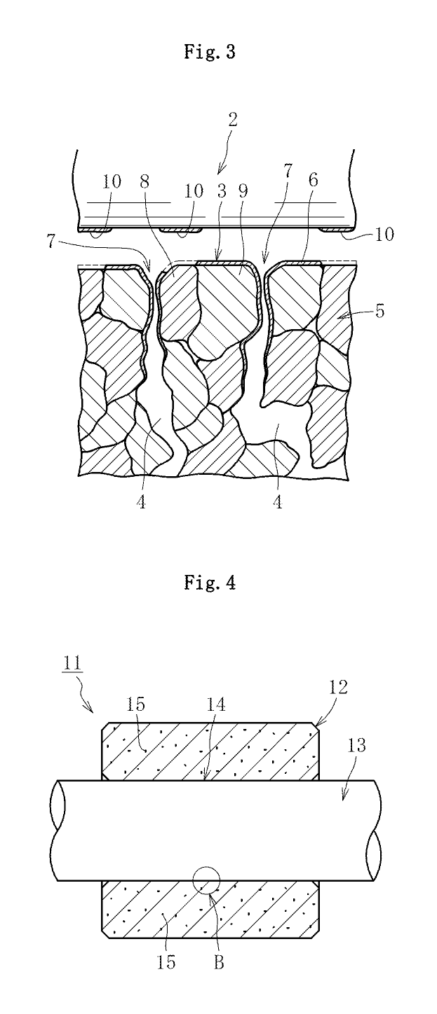

In the following, description is made of displacement of the resin film 6. As illustrated in FIG. 2, after formation of the resin film 6 on the predetermined parts of the surface of the bearing body 5 and prior to relative rotation relative to the shaft 2, an entire of the resin film 6 is in a state of adhering to the bearing body 5. Then, in this state, when the shaft 2 is rotated with respect to the bearing body 5 (sintered metal bearing 1), the surface of the shaft 2 and the resin film 6 come into sliding contact with each other. In accordance with the sliding contact, as illustrated, for example, in FIG. 3, the parts of the resin film 6 forming the sliding surface 3 are peeled off (peel) by the shaft 2 from the bearing body 5, and metal compositions positioned immediately therebelow are exposed. Further, the resin-film parts 10 thus peeled off adhere to the surface of the shaft 2 and are fixed thereto as they are. In this embodiment, the parts having stuck to a surface of the copper composition 8 having relatively low adhering properties with respect to the resin film 6 are peeled, and other parts having stuck to a surface of the iron composition 9 having relatively high adhering properties with respect to the resin film 6 remain as they are.

Further, in this case, the resin-film parts 10 peeled from the copper composition 8 of the bearing body 5 stick as they are to the surface of the shaft 2 having relatively high adhering properties with respect to the resin film 6 simultaneously with being peeled off. In many cases, the shaft 2 is made of a metal such as SUS in consideration of required strength, rigidity, processability, and the like. Thus, for example, when the shaft 2 is made of SUS, a resin, which is less likely to adhere to the copper composition 8 but can easily adhere to SUS forming the iron composition 9 and the shaft 2, is used for the resin film 6. Specifically, thermosetting resins such as an acrylic resin, an epoxy resin, a phenolic resin, and an unsaturated polyester resin can be exemplified. Further, as described above in this embodiment, when the sintered metal bearing 1 is made of a copper-iron based sintered metal and the shaft 2 is made of an iron-based metal, it is suitable to use an acrylic resin excellent in strength of bonding between iron and iron in comparison with strength of bonding between copper and copper. Note that, those resins as materials for the resin film 6 are required to have high adhering properties with respect to the shaft 2, and hence addition of filers which reduce the adhering properties should be avoided as much as possible.

In the sintered metal bearing 1 configured as described above, in accordance with the relative rotation of the shaft 2, the lubricating oil retained in the large number of inner pores 4 seeps onto the sliding surface 3 through the surface openings 7. In this way, a film of the lubricating oil is formed between the shaft 2 and the sintered metal bearing 1, and the shaft 2 is rotatably supported through intermediation of the lubricating-oil film.

Further, in accordance with the relative rotation of the shaft 2, the outer peripheral surface of the shaft 2 and the sliding surface 3 come into sliding contact with each other. As a result, the parts of the resin film 6 forming the sliding surface 3 are peeled off from the bearing body 5, and the resin-film parts 10 thus peeled off stick as they are to parts of the surface of the shaft 2, which have caused the peeling. In this way, as illustrated in FIG. 3, the outer peripheral surface of the shaft 2 is re-constituted by a part corresponding to the metal as a material for the shaft 2 and parts corresponding to the resin-film parts 10, which are newly formed by adhering. Further, the sliding surface 3 of the sintered metal bearing 1 is similarly re-constituted by residual parts of the resin film 6 and parts corresponding to a metal composition, which are newly formed by being exposed as a result of peeling of the resin film 6 (copper composition 8 in this case). In this case, in principle, the parts corresponding to the copper composition 8, which are formed by being exposed, and the resin-film parts 10 formed by adhering on the surface of the shaft 2 are formed at positions corresponding to each other in an axial direction. Thus, when the shaft 2 and the sintered metal bearing 1 come into sliding contact with each other in the state illustrated in FIG. 3, the parts corresponding to the copper composition 8 preferentially come into sliding contact with the resin-film parts 10. With this, the parts corresponding to the copper composition 8, which are formed by being exposed, are suppressed from adhering to the metal surface of the shaft 2. Thus, aggregation of other parts of the copper composition 8, which have adhered to the surface of the shaft 2, and the exposed parts of the copper composition 8 is avoided. In this way, generation of abnormal noise is prevented. Further, the peeled resin-film parts 10 adhere to the outer peripheral surface of the shaft 2 while being stretched through sliding contact of the shaft 2 and the sintered metal bearing 1. Thus, a total stick area of the resin-film parts 10 on the outer peripheral surface of the shaft 2 is larger than a total exposed area of the parts corresponding to the copper composition 8. As a result, the exposed parts of the copper composition 8 are effectively prevented from being aggregating to the shaft.

The sintered metal bearing 1 structured as described above is manufactured, for example, through a step (A) of compression-molding a raw-material powder, a step (B) of sintering a powder-press-molded body, a step (C) of sizing a sintered body (bearing body 5), a step (D) of forming the resin film 6 on the predetermined parts of the surface of the bearing body 5, and a step (E) of impregnating the lubricating oil. In the following, description is made of each of the steps.

(A) Powder-Press-Molding Step

First, a metal powder as a raw material is filled in a molding die, and then undergoes compression molding. In this way, a powder-press-molded body having a shape approximate to that of a finished product (bearing body 5) is obtained. In this case, density after the compression molding is set such that the inner pores 4 moderately remain, or as described below, set in consideration of downsizing of the inner pores 4 and the surface openings 7 in accordance with formation of the resin film 6. Note that, a powder obtained by formulating, for example, a copper powder and an iron powder at an equal ratio is used as the raw material. Alternatively, a powder obtained by formulating the copper powder and the iron powder, any one of which is formulated at a higher ratio (for example, a percentage of the total of the copper powder is set to be 60 wt % or more), may be used as the raw material. As a matter of course, a powder obtained by mixing one or a plurality of types of powders of metals other than iron and copper (including alloy powders) may be used as the raw material. Further, in expectation of a function of a binder between particles of a main-component metal powder of the same type or between main-component metal powders of different types, a low-melting metal such as an Sn powder may be added, or a solid lubricant such as graphite may be added for the purpose of improving moldability.

(B) Sintering Step

The powder-press-molded body obtained through the above-mentioned powder-press-molding step (A) is sintered by being heated up to a sintering temperature of the metal powder as a main component. In this way, the bearing body 5 is obtained. Note that, in order to avoid carburizing actions derived from sintering, sintering operations of some types of metal powders to be used may be performed in a non-carburizing atmosphere.

(C) Sizing Step

With use of an appropriate die, a compressive force is imparted to the bearing body 5 obtained through the above-mentioned step (B) so that the bearing body 5 is reshaped into a predetermined shape and dimensions thereof are finished within a predetermined range.

(D) Resin-Film Forming Step

The resin film 6 is formed on the predetermined parts of the surface of the bearing body 5 finished into a shape of a finished product through the above-mentioned steps (A) to (C). In this context, specific forming methods are arbitrarily employed in principle as long as the sliding surface 3 can be formed of the resin film 6, and a formation range of the resin film 6 is not particularly limited. Thus, for example, the resin film 6 may be formed as follows: immersing the bearing body 5 in a liquid resin as a material for the resin film 6 in an air environment or in a vacuum (reduced-pressure) environment and then taking out the bearing body 5 from the liquid resin; draining off the liquid resin adhering to a surface of the sintered body by centrifugation or the like; and curing the liquid resin adhering to the bearing body 5 by causing an appropriate curing reaction by heating or the like. In this case, as illustrated, for example, in FIG. 2, the resin film 6 is formed from an outer surface having undergone sizing to a superficial portion at a predetermined depth of the bearing body 5. Further, when a thermosetting resin is used in this case, the above-mentioned operations can be performed at normal temperature, and hence handling can be easily performed. Still further, a reduction rate of a volume in accordance with a curing reaction is higher than that of a thermoplastic resin. Thus, even when the inner pores 4 and the surface openings 7 are partially filled at the time of immersion, it is easy to secure a predetermined percentage of the inner pores 4 and the surface openings 7 without closing the same. Further, the resin film 6 can be formed at lower cost in comparison with a case where injection molding is used for formation thereof. As a matter of course, the resin film 6 only has to be formed to form the sliding surface 3 relative to the shaft 2. Thus, for example, by applying the liquid resin only to a region to be formed as the sliding surface 3 of the bearing body 5 and curing the same, the sliding surface 3 can be formed of the resin film 6 without reduction of the amount of the lubricating oil to be impregnated into the inner pores 4. As a matter of course, as long as the above-mentioned film forming condition is satisfied, it is particularly unnecessary to limit the material of the resin film 6 to the thermosetting resin, and a thermoplastic resin may be used.

(E) Lubricating-Oil Impregnation Step

The lubricating oil is impregnated into the bearing body 5 obtained through the above-mentioned step (D). Specifically, the lubricating oil is impregnated into the inner pores 4 of the bearing body 5 by immersing the bearing body 5 in a lubricating-oil bath filled with the lubricating oil for a predetermined period of time in an air environment or in a vacuum (reduced-pressure) environment. Although any lubricating oil can be used, a PAO-based lubricating oil and an ester-based lubricating oil are suitable in consideration of lubricating properties and viscosity at low temperature. Note that, in order to impregnate the above-mentioned lubricating oil into the inner pores 4 within a short period of time, an impregnation operation may be performed under a state in which the lubricating oil is heated.

Then, after the impregnation operation, an oil draining operation is performed with use of an appropriate oil-removal device. With this, except the lubricating oil impregnated in the inner pores 4 in the bearing, only surplus lubricating oil adhering to the surface of the bearing body 5 is removed. Through the above-mentioned steps, the sintered metal bearing 1 illustrated in FIG. 1 is completed.

Note that, the sintered metal bearing 1 manufactured as described above may be shipped as it is, that is, shipped as a complete product in the state illustrated in FIG. 2. However, for example, as illustrated in FIG. 3, after transferring some parts of the resin film 6 from the sintered metal bearing 1 side to the shaft 2 side by imparting appropriate rotary sliding such as running-in, the sintered metal bearing 1 and the shaft 2 may be shipped as a bearing device including those sintered metal bearing 1 and shaft 2.

Hereinabove, description has been made of the embodiment of the first invention of the present application. In this context, as a matter of course, the sintered metal bearing according to the invention of the present application is not limited to a form described above as an example, and any form may be employed within a scope of the invention of the present application. The same applies to a manufacturing method for the sintered metal bearing.

For example, with regard to the resin film 6, it suffices that the resin film 6 is formed at least on the predetermined parts of the surface (inner peripheral surface) of the bearing body 5, which form the sliding surface 3, and the resin film 6 may be formed arbitrarily onto the other parts of the surface. Thus, the resin film 6 may be formed over the entire surface of the bearing body (inner peripheral surface, outer peripheral surface, end surfaces, and chamfered portions). Further, as described above in this embodiment, the resin film 6 may be formed up to the superficial portion of the bearing body 5 including surrounding surfaces which outline the surface openings 7 (the superficial portion including surfaces which outline the inner pores 4). Alternatively, the resin film 6 may be formed only on the parts of the surface, which correspond to the sliding surface 3, or formed on all the surfaces which outline the inner pores 4 and the surface openings 7 to include a deep portion. As a matter of course, it does not matter even if the inner pores 4 and the surface openings 7 are partially closed to an extent that the lubricating oil is not hindered from being smoothly supplied.

Further, the bearing body 5 described above in this embodiment is formed of two metal compositions. However, the bearing body 5 may include a sintered metal body formed of one type or three or more types of metal compositions. In other words, one type or three or more types of metal powders may be used as raw materials for the bearing body 5 as long as the sintered metal body can be partially peeled from the bearing body 5 and can adhere to the surface of the shaft 2 in accordance with relative sliding relative to the shaft 2.

Further, as a matter of course, matters other than the above-mentioned ones also may be set in other specific forms without departing from technical significance of the first invention of the present application.

### Example 1

The following sliding test was performed in order to verify advantages of the first invention of the present application. Specifically, whether or not abnormal noise is generated at the time of relative rotation of shafts and sintered metal bearings without lubricant and a state of transfer onto shaft surfaces (fusion after transfer) were confirmed. Note that, the sliding test was performed under a state in which the sintered metal bearings are intentionally subjected to misalignment through action of a moment derived from unbalanced load.

In this test, the shafts were made of iron (any one of SKD11 and SUS420J). Further, both the sintered metal bearings were made of a copper-iron based sintered metal (content rate of an iron component was 40 wt %). As described above, a resin film that can peel from a bearing body and adhere to an outer peripheral surface of the shaft in accordance with relative sliding of the shaft was formed. One of the prepared sintered metal bearings had a sliding surface formed of the above-mentioned resin film (Example) and another of the prepared sintered metal bearings had a sliding surface formed of a sintered metal itself (Comparative Example). The sliding test was performed with use of those sintered metal bearings.

Table 1 below shows results of the test. As is understood from the table, it was confirmed that abnormal noise was generated 5 minutes after a start of the sliding in a conventional sintered metal bearing free from a predetermined resin film (Comparative Example). Further, as a result of checking an outer peripheral surface of the shaft after the sliding test, it was confirmed that copper forming the sliding surface of the sintered metal bearing adhered to the outer peripheral surface. In contrast, with regard to the sintered metal bearing provided with a predetermined resin film, generation of abnormal noise was not confirmed until the end of the sliding test. Further, it was found that parts of the resin film formed on the bearing body were scattered on the outer peripheral surface of the shaft after the test. Parts of the resin film probably hindered copper from adhering to iron.

TABLE 1

| | Comparative Example | Example |
|---|---|---|
| Sliding surface | Sintered metal | Resin film (acrylic |
| | (copper-iron based) | resin) |
| Generation of | Observed (5 minutes | None (throughout 180 |
| abnormal noise | after start of test) | minutes) |
| Surface of shaft | Remarkable transfer | No transfer of copper |
| | of copper | (only resin |
| | | transferred) |

In the following, description is made of an embodiment of a second invention of the present application with reference to FIGS. 4 to 6. Here, as an example, description is made of a case where a shaft member including an iron-based shaft body is used with respect to a copper-iron based sintered bearing.

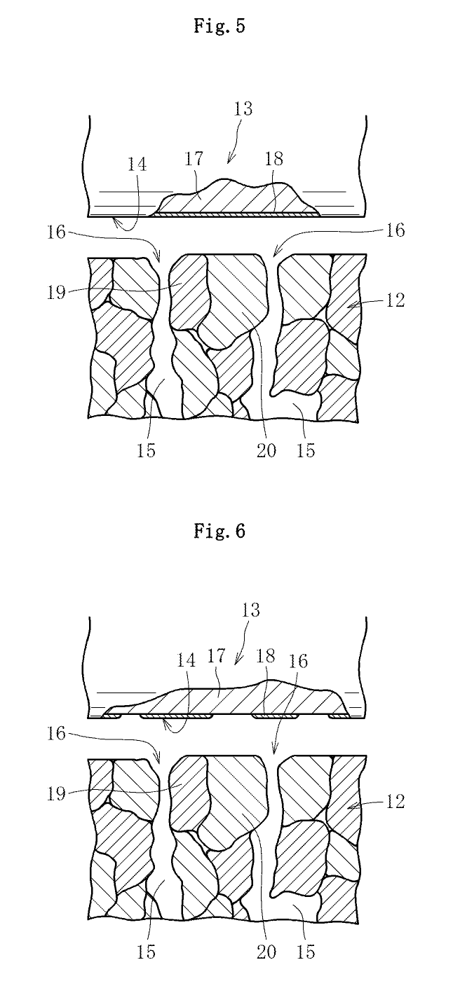

FIG. 4 is a partial vertical sectional view of a sliding bearing unit 11 according to one embodiment of the second invention of the present application. In this embodiment, the sliding bearing unit 11 includes a sintered metal bearing 12 and a shaft member for sliding bearing unit (hereinafter, simply referred to as shaft member) 13 arranged along an inner periphery of the sintered metal bearing 12. A sliding surface 14 is provided in a region of an outer peripheral surface of the shaft member 13, which faces an inner peripheral surface of the sintered metal bearing 12. Further, a large number of pores (inner pores 15) are provided in the sintered metal bearing 12, and a lubricating oil is impregnated in those inner pores 15. As illustrated, for example, in FIG. 5, those large number of inner pores 15 communicate to surface openings 16 opened in the inner peripheral surface of the sintered metal bearing 12. In accordance with relative rotation of the shaft member 13, the lubricating oil retained in the inner pores 15 seeps into a gap with respect to the sliding surface 14 (bearing clearance) through the surface openings 16.

FIG. 5 is an enlarged sectional view of the region B in FIG. 4, that is, around the sliding surface 14 of the shaft member 13. As illustrated in FIG. 5, the shaft member 13 includes a metal shaft body 17 and a resin film 18 formed on predetermined parts of a surface of the shaft body 17, that is, at least in a region (some parts on the outer peripheral surface) to serve as the sliding surface 14 relative to the sintered metal bearing 12.

Further, the sintered metal bearing 12 is obtained by compression molding one type or two or more types of metal powders (including both single metals and alloys) as raw materials, and then sintering the same. In this embodiment, the sintered metal bearing 12 is formed of two types of metal powders, specifically, a copper powder and an iron powder as raw materials. Thus, as illustrated in FIG. 5, the sintered metal bearing 12 has a structure in which a composition 19 formed mainly of copper (hereinafter, simply referred to as copper composition) and another composition 20 formed mainly of iron (hereinafter, simply referred to as iron composition) are mixed with each other. In this case, the region facing the sliding surface 14 (inner peripheral surface of the sintered metal bearing 12) is formed of the copper composition 19 and the iron composition 20.

In this case, the resin film 18 is formed in a state of adhering to the predetermined parts of the surface of the shaft body 17. As described below, a material, a film thickness, a film forming condition, and the like of the resin film 18 are set such that parts of the resin film 18 peel from the shaft body 17 (shaft member 13) in accordance with relative sliding relative to the sintered metal bearing 12, and that other parts of the resin film 18, which come into sliding contact mainly with the copper composition 19 having lower adhering properties with respect to the resin film 18 that those of the shaft body 17, do not peel as much as possible. As a matter of course, adhering properties of the resin film 18 with respect to the sintered metal bearing 12 and the shaft body 17 may be set in consideration of bearing use conditions such as a rotational speed of and load (surface pressure imparted to the sliding surface 14 during rotation) on the shaft member 13. Further, materials for the shaft body 17 and the sintered metal bearing 12 need to be selected in consideration not only of adhering properties with respect to the resin film 18 but also of other factors (strength, rigidity, abrasion resistance, conductivity, processability, swelling (resin alteration caused by lubricating oil), and the like). Thus, the materials for the shaft body 17 and the sintered metal bearing 12 may be determined first in consideration of those factors, and then the resin satisfying the above-mentioned condition may be selected.

In the following, description is made of displacement of the resin film 18. As illustrated in FIG. 5, after formation of the resin film 18 on the predetermined parts of the surface of the shaft body 17 and prior to relative rotation with respect to the sintered metal bearing 12, an entire of the resin film 18 is in a state of adhering to the shaft body 17. Then, in this state, when the shaft member 13 and the sintered metal bearing 12 are rotated relatively to each other, the inner peripheral surface of the sintered metal bearing 12 and the resin film 18 come into sliding contact with each other. In accordance with the sliding contact, as illustrated, for example, in FIG. 6, the parts of the resin film 18 forming the sliding surface 14 are peeled off (peel) from the shaft body 17, and parts of an outer peripheral surface of the shaft body 17, which correspond to the parts thus peeled off, are exposed. In this embodiment, the resin film 18 is less liable to peel at parts which come into sliding contact mainly with the copper composition 19 having relatively low adhering properties with respect to the resin film 18, and the resin film 18 is liable to peel off at parts which come into sliding contact mainly with the iron composition 20 having relatively high adhering properties with respect to the resin film 18.

In this context, the shaft body 17 formed to serve as a base of the shaft member 13 is made of an iron-based metal such as SUS in consideration of required strength, rigidity, processability, and the like. For example, when the shaft body 17 is made of SUS, a resin excellent in adhering properties with respect to SUS (shaft body 17) than with respect to copper (copper composition 19) is used for the resin film 18. Further, depending on combinations of the resin to be used for the resin film 18 and respective metals, at the same time when the parts of the resin film 18, which have been peeled from the shaft body 17, are peeled off, the parts thus peeled off can be stuck as they are to the surface of the metal composition having relatively high adhering properties with respect to the resin film 18. In other words, resins having adhering properties with respect to other metal compositions (iron composition 20 in this case) equivalent to the shaft body 17 or more excellent than the shaft body 17 can be used. As resins satisfying both the above-mentioned conditions, thermosetting resins such as an acrylic resin, an epoxy resin, a phenolic resin, and an unsaturated polyester resin can be exemplified. Further, of those resins, when the sliding bearing unit 11 is made of a copper-iron based sintered metal and the shaft body 17 is made of an iron-based metal such as SUS as described above in this embodiment, it is suitable to use an acrylic resin excellent in strength of bonding between iron and iron in comparison with strength of bonding between copper and copper.

In the sliding bearing unit 11 configured as described above, in accordance with the relative rotation of the shaft member 13, the lubricating oil retained in the large number of inner pores 15 seeps onto the sliding surface 14 through the surface openings 16. In this way, a film of the lubricating oil is formed between the shaft member 13 and the sintered metal bearing 12 (bearing gap), and the shaft member 13 is rotatably supported through intermediation of the lubricating-oil film.

Further, in accordance with the relative rotation of the shaft member 13, the sliding surface 14 provided to the shaft member 13 and the inner peripheral surface of the sintered metal bearing 12 come into sliding contact with each other. As a result, the parts of the resin film 18 forming the sliding surface 14 are peeled off from the shaft body 17. In this way, as illustrated in FIG. 6, the outer peripheral surface of the shaft member 13 is re-constituted by exposed parts of the outer peripheral surface of the shaft body 17 and unpeeled parts of the resin film 18 remaining on the shaft body 17. In this case, many of the peeled parts are found mainly at parts which come into sliding contact with the iron composition 20 of the sintered metal bearing 12. Many of the unpeeled remaining parts of the resin film 18 are found at parts which come into sliding contact with the copper composition 19. In this context, of the two metal compositions forming the sintered metal bearing 12, the copper composition 19 has properties of being more easily trimmed by and adhering to the shaft body 17 made of SUS than the iron composition 20. Therefore, it is necessary to avoid contact between the shaft body 17 and the copper composition 19 rather than contact between the shaft body 17 and the iron composition 20. Thus, when the shaft member 13 and the sintered metal bearing 12 undergo rotary sliding in the state illustrated in FIG. 6, the parts of the resin film 18, which remain unpeeled on the shaft body 17, preferentially come into sliding contact with the copper composition 19. Further, remaining parts of the resin film 18 or other parts of the resin film 18, which have peeled and floated, are interposed between the shaft member 13 and the sintered metal bearing 14, specifically, in sliding-contact portions with respect to the iron composition 20, those parts of the resin film 18 are stretched and enlarged. In this way, the copper composition 19 is suppressed from adhering to the outer peripheral surface of the shaft body 17, and hence aggregation of the copper composition 19 is avoided. As a result, generation of abnormal noise is prevented.

Further, as in this embodiment, the sintered metal bearing 12 formed of the copper composition 19 and the iron composition 20 is formed by mixing, compressing, and baking the copper powder and the iron power. Thus, the copper composition 19 and the iron composition 20 are evenly distributed in an inner peripheral surface facing the sliding surface 14. As a result, aggregation of copper can be suppressed over the entire of the sliding surface 14, and hence generation of abnormal noise is more reliably prevented. Further, when the peeled parts of the resin film 18 adhere to the iron composition 20 of the sintered metal bearing 12, the peeled parts of the resin film 18 are not contained as impurities in the lubricating oil. As a result, performance of the lubricating oil is prevented from being deteriorated.

The shaft member 13 for sliding bearing unit structured as described above is manufactured through a step of manufacturing the shaft body 17 and a step of forming the resin film 18 on the predetermined parts of the surface of the shaft body 17 thus manufactured. In this context, the shaft body 17 can be manufactured as follows: roughly molding a metal raw material such as SUS by forging or the like; then grinding the entire surface thereof; and lastly, performing a finishing process such as polishing on a region to serve as the sliding surface 14 (region in which the resin film 18 is formed). Further, an outer shape of the shaft body 17 may be formed to some extent by a machining process such as trimming, and then finished as a final shape by grinding, polishing, or the like. As a matter of course, the shaft body 17 can be manufactured through other processing steps. For example, the shaft body 17 may be manufactured by performing sizing on predetermined parts of a surface of a sintered metal which is used as a raw material.

Further, the resin film 18 is formed by solidifying a liquid resin as a material for the resin film 18, which is supplied onto the predetermined parts of the surface of the shaft body 17 manufactured through the above-mentioned steps. In this context, specific forming methods are arbitrarily employed in principle as long as the sliding surface 14 can be formed of the resin film 18, and a formation range of the resin film 18 is not particularly limited. Thus, for example, the resin film 18 may be formed as follows: immersing the shaft body 17 in the liquid resin as a material for the resin film 18; taking out the shaft body 17 from the liquid resin into a perpendicular direction (film thickness is reduced when the shaft body 17 is taken out slowly); and then curing as it is the liquid resin adhering to the surface of the shaft body 17 by causing an appropriate curing reaction by heating or the like. Further, it is necessary that the resin film 18 be formed to partially peel at the time of sliding, and hence the above-mentioned liquid resin may supplied in a mist form with a spray and the like. With this, the resin film 18 can be formed to be markedly thin on the shaft body 17. As the resin film 18 becomes thinner, the influence on a dimensional tolerance of the bearing gap is reduced. Thus, it is effective to employ a method of supplying a thermosetting resin which largely shrinks on curing in a thin-film form by a spray coating method. Even when any method is employed, the resin film 18 can be formed at low cost in comparison with a case where the resin film 18 is molded by injection molding. As a matter of course, the resin film 18 only has to be formed to form the sliding surface 14, and hence it is unnecessary to form the resin film 18 over all the surfaces of the shaft body 17. Note that, as long as the above-mentioned film forming condition is satisfied, it is particularly unnecessary to limit the material of the resin film 18 to the thermosetting resin, and a thermoplastic resin may be used.

By combining the shaft member 13 manufactured as described above with the sintered metal bearing 12 corresponding thereto, the sliding bearing unit 11 illustrated in FIG. 4 is completed.

Note that, the sliding bearing unit 11 manufactured as described above may be shipped as it is, that is, shipped as a complete product in the state illustrated in FIG. 5. However, for example, as illustrated in FIG. 6, the sliding bearing unit 11 may be formed of the resin film 18, which has been partially peeled by undergoing appropriate rotary sliding such as running-in, and another new sintered metal bearing 12 combined with each other so as to be shipped as a complete product.

Hereinabove, description has been made of the embodiment of the second invention of the present application. In this context, as a matter of course, the shaft member for sliding bearing unit according to the invention of the present application is not limited to a form described above as an example, and any form may be employed within a scope of the invention of the present application. The same applies to a manufacturing method for the shaft member for sliding bearing unit.

Further, as a matter of course, matters other than the shaft member 13 (such as a composition of and a manufacturing method for the sintered metal bearing 12, and a type of lubricant including the lubricating oil) may be set in other specific forms without departing from technical significance of the second invention of the present application.

### Example 2

The following sliding test was performed in order to verify advantages of the second invention of the present application. Specifically, whether or not abnormal noise was generated at the time of relative rotation of shaft members and sintered metal bearings without lubricant and a state of transfer onto bearing inner-peripheral surfaces (fusion after transfer) were confirmed. Note that, the sliding test was performed under a state in which the sintered metal bearings are intentionally subjected to misalignment through action of a moment derived from unbalanced load.

In this test, both the sintered metal bearings were made of a copper-iron based sintered metal (content rate of an iron component was 40 wt %). A shaft body as a base of each of the shaft members was made of iron (any one of SKD11 and SUS420J). A resin film which peels from the shaft body in accordance with relative sliding relative to each of the sintered metal bearings and is excellent in adhering properties with respect to the shaft body than with respect to one of the metal compositions (copper composition) of each of the sintered metal bearings was formed on the shaft body. One of the prepared sintered metal bearings had a sliding surface formed of the above-mentioned resin film (Example) and another of the prepared sintered metal bearings had a sliding surface formed of an outer peripheral surface of the shaft body (Comparative Example). The sliding test was performed with use of those sintered metal bearings. An acrylic resin was used for the resin film.

Table 2 below shows results of the test. As is understood from the table, it was confirmed that abnormal noise was generated 5 minutes after a start of the sliding when a conventional shaft member free from a predetermined resin film (Comparative Example) is used. Further, as a result of checking a sliding surface (outer peripheral surface) of the shaft member after the sliding test, it was confirmed that copper forming the sliding surface of the sintered metal bearing adhered to the sliding surface. In contrast, when the shaft member provided with a predetermined resin film is used, generation of abnormal noise was not confirmed until the end of the sliding test. Further, although parts of the resin film formed on the shaft body remained on the outer peripheral surface of the shaft after the test, adhesion of copper was not found. Although the resin film partially peeled relative to a state prior to sliding, the parts of the resin film remaining unpeeled probably hindered copper from adhering to the shaft body.

TABLE 2

| | Comparative Example | Example |
|---|---|---|
| Sliding surface | Shaft body itself | Resin film (acrylic |
| | (iron based) | resin) |
| Generation of | Observed (5 minutes | None (throughout 180 |
| abnormal noise | after start of test) | minutes) |
| Surface of shaft | Remarkable transfer | No transfer of copper |
| | of copper | (only resin |
| | | transferred) |

### REFERENCE SIGNS LIST

1 sintered metal bearing
2 shaft
3 sliding surface
4 inner pore
5 bearing body
6 resin film
7 surface opening
8 copper composition
9 iron composition
10 resin-film part
11 sliding bearing unit
12 sintered metal bearing
13 shaft member
14 sliding surface
15 inner pore
16 surface opening
17 shaft body
18 resin film
19 copper composition
20 iron composition

1. A sintered metal bearing, comprising:
a sliding surface relative to a shaft;
a sintered-metal bearing body formed of a metal composition different from a metal composition of the shaft and comprising a large number of inner pores; and
a resin film formed on predetermined parts of a surface of the sintered-metal bearing body and forming the sliding surface,
wherein the resin film is formed so that surface openings communicating to the large number of inner pores are kept opened, and the resin film partially peels from the sintered-metal bearing body in accordance with relative sliding relative to the shaft to adhere to a surface of the shaft.

2. A sintered metal bearing according to claim 1,
wherein the metal composition of the sintered-metal bearing body comprises at least two types of metals each having different adhering properties with respect to the resin film, and
wherein the resin film peels from one of the at least two types of the metals forming the metal composition at the time of the relative sliding relative to the shaft and maintains a adhering state with respect to another of the at least two types of the metals.

3. A sintered metal bearing according to claim 1 or 2, wherein the resin film is made of a resin excellent in adhering properties with respect to the shaft than with respect to the sintered-metal bearing body.

4. A sintered metal bearing according to claim 3, wherein the resin film is made of one type of resin selected from a group consisting of an acrylic resin, an epoxy resin, a phenolic resin, and an unsaturated polyester resin.

5. A sintered metal bearing according claim 1 or 2, wherein a lubricating oil is impregnated in the large number of inner pores.

6. A bearing device, comprising:
the sintered metal bearing according to claim 1 or 2; and
a shaft arranged along an inner periphery of the sintered metal bearing.

7. A shaft member for sliding bearing unit, which is to be used for a sintered-metal sliding bearing comprising one type of a metal composition or two or more types of metal compositions, comprising:
a sliding surface relative to the sintered-metal sliding bearing;
a metal shaft body; and
a resin film formed on predetermined parts of a surface of the metal shaft body and forming the sliding surface,
wherein the resin film is made of a resin excellent in adhering properties with respect to the metal shaft body than with respect to predetermined one of the one type of the metal composition or the two or more types of the metal compositions forming the sintered-metal sliding bearing, and the resin film only partially peels from the metal shaft body in accordance with relative sliding relative to the sintered-metal sliding bearing.

8. A shaft member for sliding bearing unit according to claim 7, wherein the resin film is made of one type of resin selected from a group consisting of an acrylic resin, an epoxy resin, a phenolic resin, and an unsaturated polyester resin.

9. A sliding bearing unit, comprising:
the shaft member according to claim 7 or 8; and
a sintered-metal sliding bearing having an inner periphery along which the shaft member is arranged.

10. A sliding bearing unit according to claim 9, wherein the sintered-metal sliding bearing comprises a metal composition formed mainly of copper.

11. A sliding bearing unit according to claim 9, wherein the sintered-metal sliding bearing comprises two or more types of metal compositions each having different adhering properties with respect to the resin film.

12. A sliding bearing unit according to claim 9, wherein a lubricating oil is impregnated in inner pores of the sintered-metal sliding bearing.
